(19) United States
(12) Patent Application Publication
(10) Pub. No.: US 2026/0291046 A1
(43) Pub. Date: Sep. 24, 2026

(54) METHOD AND DEVICE FOR CHANGING POSITION OF AT LEAST ONE ALIGNMENT MEANS

(71) Applicant: Telefonaktiebolaget LM Ericsson (publ), Stockholm (SE)

(72) Inventors: Sam AGNEESSENS, Torslanda (SE); Lars MANHOLM, Göteborg (SE); Oskar TALCOTH, Göteborg (SE)

(73) Assignee: Telefonaktiebolaget LM Ericsson (publ), Stockholm (SE)

(21) Appl. No.: 19/475,404

(22) PCT Filed: Apr. 19, 2023
(86) PCT No.: PCT/EP2023/060160

§ 371 Date: Oct. 14, 2025

(51) Int. Cl. H01Q 1/12; H01Q 3/02

(52) U.S. Cl. CPC H01Q 1/1257; H01Q 3/02

(57) ABSTRACT

The present disclosure relates to a method performed by a device (101) for changing position of at least one alignment means (109) to align a radio communication antenna (105) mounted to a mounting structure (313). The device (101) connects the device (101) to the at least one alignment means (109) and obtains at least one performance parameter from a radio communication device (110) associated with the radio communication antenna (105). The device (101) determines a position change of the at least one alignment means (109) based on the at least one performance parameter. The device (101) performs the position change of the at least one alignment means (109) and thereby aligning the radio communication antenna (105).

### TECHNICAL FIELD

The present disclosure relates generally to a device and a method performed by the device. More particularly, the present disclosure relates to changing position of at least one alignment means to align a radio communication antenna mounted to a mounting structure.

### BACKGROUND

During installation, alignment of a radio communication antenna is important. For example, misalignment of the antenna may cause unstable antenna operation, it may affect the quality and reliability of the radio signals transmitted and/or received by the antenna etc. Alignment is also important during operation of the antenna since the antenna may be misaligned by for example wind, by vibrations on the ground caused by vehicles etc. The term antenna may be used herein when referring to a radio communication antenna.

Aligning an antenna may be described as adjusting or changing the orientation of the antenna, i.e. adjusting or changing the azimuth, elevation and polarization angle of the antenna. The alignment of an antenna may be done with respect to another antenna, i.e. two antennas are aligned with respect to each other, or the alignment of an antenna may be done with respect to a predetermined alignment parameter.

One example of an antenna is a high gain antenna which is much used in point-to-point communication. A high gain antenna may be described as an antenna with a focused beam with a narrow beam width. A high gain antenna may be referred to as a directional antenna. A high gain antenna enables precise targeting of the radio signals that it transmits. Antennas with antenna gains of up to 50 dBi, and likely more in the future, are often needed to achieve the necessary link gain and hence the capacity and availability of the link.

A consequence of the narrow beam width of these high gain antennas is that it may be challenging to align them during installation and during operation. It is self-evident that proper alignment is important since misalignment of less than a degree of either of the antennas on the link can have an impact on the link gain in the order of tens of dBs. For example, a 50 dBi reflector antenna has a Half Power Beam Width (HPBW) of 0.5 deg.

A perfectly aligned antenna, i.e. aligned in the exact center of the beam, also makes the link much more robust against any misalignment that might happen during the lifetime of the link, e.g. 10-20 years, such as alignment degradation over time, e.g. antenna movement during a storm, or sway of the mounting structure, e.g. thermal induced tower bending, wind-induced tower bending, vibrations introduced by road/rail traffic.

Currently, alignment of an antenna is done manually by an operator. The operator climbs the mounting structure and aligns the antenna visually, i.e. he/she tries to point the antenna in the right direction. Once this rough alignment is done, the operator uses alignment means such as screws, bolts etc. on the antenna mounting structure, e.g. a mast, a tower, a pole etc., to fine tune the orientation of the antenna. To determine the proper orientation, the operator obtains a performance parameter value from a radio communication device associated with the antenna, e.g., by inserting a voltmeter into an Operations and Maintenance (O&M) port of the radio. For the sake of simplicity, the term radio is used herein when referring to the radio communication device.

Once the best orientation of the antenna is found by the operator, the operator fixes the antenna orientation by tightening at least one fastening means. Several things here make that this alignment is very error prone:
There may be a measurement error on the performance parameter value displayed on the voltmeter.
The accuracy of the manual adjustment of the alignment means relies on the competence of the operator.
During the fixating step, great care is needed not to misalign the antenna again. In particular, mounting structure designs where fastening has not been decoupled from alignment fine-tuning make this task difficult.
On unstable mounting structures, it is possible that the mounting structure moves due to the presence of the operator in/on the mounting structure.

Installation also must be done by trained and competent personnel that need to climb the mounting structure. When a new link is installed, it is not uncommon to have a team of operators at each antenna site at the same time. They then communicate and synchronize through telephone to be able to do the alignment on both sides in an iterative procedure.

It is extremely difficult to align an antenna when the mounting structure is moving, for example due to wind or due to the fact that the operator is in or on the mounting structure, e.g. in the tower or on the monopole. Similarly, mounting structures that bend by uneven thermal expansion due to sunlight during the day can misalign a perfectly aligned antenna when returning to their unbent state. In such cases, antenna alignment should preferably be performed during the night or during cloudy weather, which comes with additional safety risks. In the future, we will probably see more of these less stable installations.

Therefore, there is a need to at least mitigate or solve this issue.

### SUMMARY

An objective is to obviate at least one of the above disadvantages and to improve alignment of a radio communication antenna.

According to a first aspect, the objective is achieved by a method performed by a device for changing position of at least one alignment means to align a radio communication antenna mounted to a mounting structure. The device is connected to the at least one alignment means. The device obtains at least one performance parameter from a radio communication device associated with the radio communication antenna. The device determines a position change of the at least one alignment means based on the at least one performance parameter. The device performs the position change of the at least one alignment means and thereby aligning the radio communication antenna.

According to a second aspect, the objective is achieved by device for changing position of at least one alignment means to align a radio communication antenna mounted to a mounting structure. The device is arranged to connect to the at least one alignment means. The device is arranged to obtain at least one performance parameter from a radio communication device associated with the radio communication antenna. The device is arranged to determine a position change of the at least one alignment means based on the at least one performance parameter. The device is arranged to perform the position change of the at least one alignment means and thereby aligning the radio communication antenna.

Thanks to that the device obtains the at least one performance parameter, it can use the at least one performance parameter to change the position of the at least one alignment means such that the alignment of the antenna is optimal. An optimal alignment of the antenna may comprise that the antenna alignment maximizes the performance parameter in the direction towards the target, e.g. another antenna. When the device is connected to the at least one alignment means, it can automatically change the position of the at least one alignment means, without any manual position change performed by the operator, and thereby automatically align the antenna. Thus, alignment of the antenna is improved.

The present disclosure herein affords many advantages, of which a non-exhaustive list of examples follows:

An advantage of the present disclosure is that alignment of the antenna is made easier, faster, more accurate, as compared to the manual alignment currently performed.

Another advantage of the present disclosure is that the device is easy to use and requires less training or less complex training of the operator, as compared to the currently used manual alignment. Thus, the alignment can be done by less trained personnel and with less personnel.

A further advantage of the present disclosure is that the device enables the alignment, to be done without having an operator located in the mounting structure. Thus, a potential source of sway in the mounting structure is removed.

A yet further advantage of the present disclosure is that the operator safety is increased as time working at heights is reduced. If the device is mounted on a drone which carries the device up to the mounting position in the mounting structure and positions the device such that it connects to the at least one alignment means, there is no need for an operator to climb the mounting structure, e.g. a tower, a mast, a pole etc., anymore to do realignment.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings in which:

FIG. 1 is a schematic drawing illustrating antenna alignment.

FIG. 2 is a schematic drawing illustrating antenna alignment.

FIG. 3 is a flow chart illustrating a method.

FIG. 4 is a flow chart illustrating a method.

FIG. 5 is a flow chart illustrating a method.

The drawings are not necessarily to scale, and the dimensions of certain features may have been exaggerated for the sake of clarity. Emphasis is instead placed upon illustrating the principle.

### DETAILED DESCRIPTION

The present disclosure relates to a device that automates the alignment of a radio communication antenna.

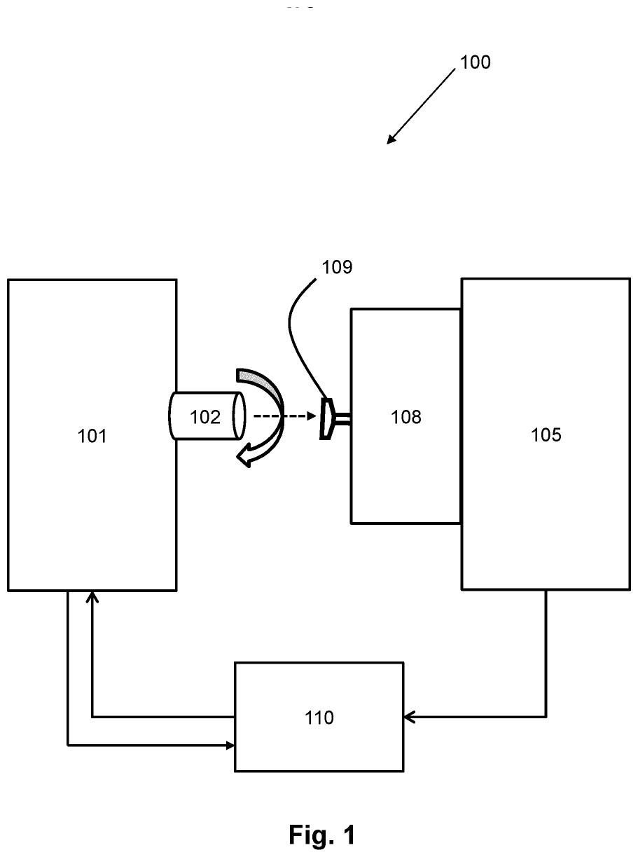

FIG. 1 is a schematic block diagram illustrating an antenna system 100. FIG. 1 illustrates that the antenna system 100 comprises a device 101. The device 101 may be referred to as a tool, an alignment tool, an alignment device, a radio antenna alignment device etc. The device 101 is arranged to enable alignment of a radio communication antenna 105. The antenna 105 may be an antenna arranged for a point-to-point wireless link. The antenna 105 may be a high gain antenna. The antenna 105 may be a high gain reflector antenna for wireless backhaul. The antenna 105 may be any suitable type of antenna, for example at panel antenna, array antenna, lens antenna etc. The term antenna together with the reference number 105 may be used herein for the sake of simplicity when referring to the radio communication antenna 105.

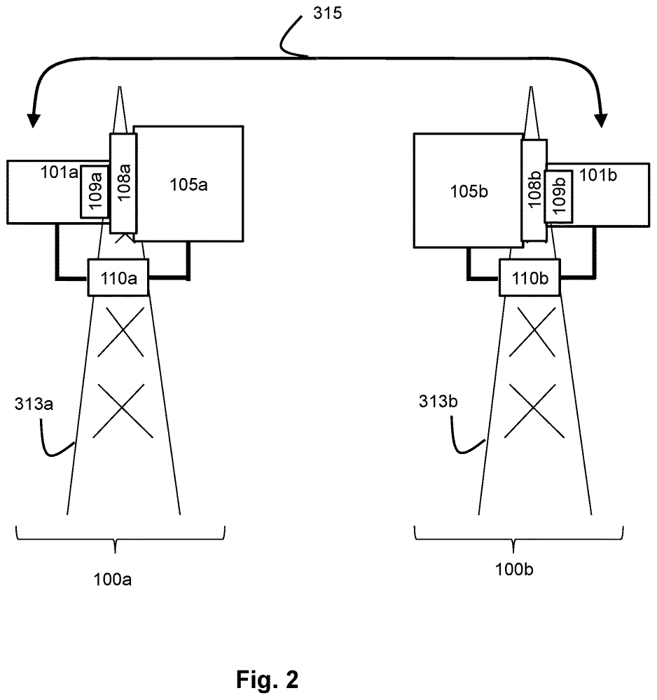

The antenna 105 is arranged to be mounted to a mounting structure (not illustrated in FIG. 1), e.g. a mast, a tower, a pole etc. The mounting structure is illustrated in FIG. 2.

The device 101 may comprise one or more of the following parts:
A mechanical interface, e.g. a manipulator 102, that allows for manipulation of an alignment means 109. The alignment means 109 may be connected to an antenna mount 108.
Actuators that automate the manipulation of the alignment means 109.
An interface to a radio communication device 110 for exchange of information to find the optimal antenna alignment. The optimal antenna alignment may be associated with a performance parameter. The interface may be used by the device 101 to configure the radio 110.
Processor and memory.
Power supply: Batteries or power received from the radio communication device 110.
User interface, for example buttons, a display, a touchscreen, an audio input, audio output etc.

The term radio together with the reference number 110 may be used herein for the sake of simplicity when referring to the radio communication device 110

Some details of the parts in the list above will now be provided.

The device 101 comprises at least one actuator (not illustrated in FIG. 1) and at least one manipulator 102. The actuator is arranged to move the manipulator 102. The manipulator 102 has a shape arranged to fit and connect to an alignment means 109. The alignment means 109 is arranged to be connected to the antenna 105 such that the antenna 105 is aligned after the alignment means 109 has been moved by the device 101, e.g. by the actuator and the manipulator 102 comprised in the device 101. The device 101 is an automatic device, i.e. it automatically changes the position of the alignment means 109, as in contrast to the manual alignment performed by an operator who manually changes the position of the alignment means 109 by hand. The device 101 is automatic in that it comprises the actuator arranged to move the manipulator. The actuator is comprised in a machine, i.e. an electric machine, and the machine is comprised in the device 101. The machine is powered by any suitable powering means, e.g. a battery, an electric cable etc.

The shape of the manipulator 102 is such that it can connect to the alignment means 109 in order to change the position of the alignment means 109, and thereby align the antenna 105. For example, the manipulator 102 may be a magnet or comprise a magnet and the alignment means 109 may be of a material attractable by the magnet. In another example, the manipulator 102 may have a cylindrical and hollow shape and the alignment means 109 may have shape such that it can be inserted into the cylindrical and hollow manipulator 102. In a further example, the manipulator may be a female unit and the alignment means 109 may be a male unit, or vice versa. Summarized, the manipulator 102 and the alignment means 109 are arranged to be connected to each other.

The manipulator 102 is arranged to move the alignment means 109. Moving the alignment means 109 may comprise to change the position of the alignment means 109, to rotate the alignment means 109 (as exemplified with the arrow in FIG. 1) for example if the alignment means 109 is arranged to be screwed, to push and/or pull the alignment means 109 in any suitable direction etc.

Note that one manipulator 102 and one alignment means 109 are illustrated as only an example in FIG. 1, and that the device 101 may comprise any number of actuators and manipulators 102, and that there may be any number of alignment means 109. For example, the device 101 may be arranged to connect to one alignment means, it may be arranged to connect to two alignment means 109 at the same time, it may be arranged to connect to three or to n number of alignment means 109 at the same time, where n is a positive integer. The number of manipulators 102 and the number of alignment means 109 are the same.

The alignment means 109 may have the shape of a screw, a bolt, a bolt comprising a nut, a pin, a nail or any other suitable alignment means 109. There may be separate fastening means arranged to hold the antenna 105 in place. Thus, the alignment means 109 are dedicated for alignment of the antenna 105.

The alignment means 109 is arranged to enable alignment of the antenna 105. When the position of the alignment means 109 is moved, e.g. rotated by means of the device 101, the orientation of the antenna 105 is changed, for example with respect to a reference alignment parameter, with respect to another antenna or with respect to any other suitable reference.

There may be an antenna mount 108 between the alignment means 109 and the antenna 105 to improve the connection between the alignment means 109 and the antenna 105, to keep the alignment means 109 in place when it has been fastened etc. The antenna mount 108 may be arranged to fit to one alignment means 109 or to two or more alignment means 109 at the same time. The mount 108 may be a separate and standalone unit that is releasably connected between the alignment means 109 and the antenna 105 or it may be a part of the antenna 105, i.e. it may be integrated in the antenna 105. The antenna mount 108 may have any shape suitable for connecting to the alignment means 109. The antenna mount 108 may be a bracket.

A radio 110 is arranged to be connected to the antenna 105 and the device 101. The antenna 105 is arranged to convert unguided electromagnetic (EM) waves, i.e. that propagate in air, to guided EM waves, i.e. that propagate along or inside something, e.g. a waveguide, a coaxial cable, a transmission line. In contrast, the radio 110 is arranged to process guided EM waves. For example, it can generate and receive EM waves. The radio 110 is arranged to obtain Radio Frequency (RF) information from the antenna 105. The radio 110 is arranged to estimate a signal level of the RF signal or to estimate a measure of signal quality and to provide one or more performance parameters to the device 110. The performance parameter may be for example a signal level, a signal quality, a Block Level Error Rate (BLER) etc.

The radio 110 may be arranged to obtain information, e.g. configuration settings, from the device 101.

The radio 110 may be connected to the antenna 105 via wired link. The radio 110 and the device 101 may be connected to each other via a wireless link, or they may be connected via a wired link, or they may be connected via a combination of a wired link and a wireless link. The radio 110 may be connected to, i.e. mounted on, the mounting structure, or it may be located at some distance from the mounting structure, but still being arranged to communicate with the antenna 105 which is mounted to the mounting structure.

The device 101 may comprise a user interface (not illustrated in FIG. 1), or the device 101 may be arranged to be connected to an external user interface, or the device may both comprise a user interface and connected to an external user interface. Thus, the user interface may be included in the device 101 or it may be in a separate and standalone unit such as a User Equipment (UE), e.g. a mobile phone, a tablet computer etc., or there may be a user interface both comprised in the device 101 at the same time as the device 101 is arranged to be connected to an external user interface.

The operator may control the device 101 via the user interface. The operator may perform a number of control operations via the user interface, for example he/she may set the goals to be reached, e.g. which performance parameter to optimize, he/she may specify to which bolt the device 202 is attached, he/she may specify the type of mounting structure 313, he/she may start and stop the alignment procedure, etc.

The operator which mounts the device 101 on the alignment means 109 or any other user may provide user input via the user interface. The operator may be referred to as a user, an installer etc. The user input may be for example a start signal which triggers the start of the alignment procedure, a stop signal that triggers the stop of the alignment procedure, it may be information about a performance threshold. The device 101 may provide user output via the user interface, for example an alarm signal, a ready signal, information about the monitored performance parameter, information about the position change etc. The user interface may be arranged to obtain audio input, textual input, image input, and it may be arranged to provide audio output, textual output, image output etc.

The operator of the antenna 105 may initially perform a manual alignment of the antenna before the device 101 performs the automatic alignment. Once the rough alignment is done by the operator, the device 101 is used to do the final fine-tuned alignment. The device 101 may be removed after the alignment is completed, but it is also possible to leave the device 101 connected to the alignment means 109 even after the operator has left the antenna site. This is a way of enabling automatic realignment of the antenna 105 without the need for a site visit, or an easy upgrade to mitigate deployments that suffer from slow mounting structure sway.

Summarized, the device 101 acts on the alignment means 109 of the antenna 105 through the manipulators 102 to adjust the alignment of the antenna 105. The device 101 uses performance parameters such as e.g. RSL from the radio 110 to find the optimal alignment. The optimal alignment is achieved by changing the position of the alignment means 109. The optimal alignment may be associated with a predetermined performance parameter threshold that needs to be fulfilled.

FIG. 2 is a schematic drawing illustrating two antenna systems, i.e. a first antenna system 100a and a second antenna system 100b. The antenna system 100 illustrated in FIG. 1 may be any of the two antenna systems in FIG. 2. In FIG. 2, the letter a is used in the reference numbers when referring to the first antenna system 100a and the letter b is used in the reference numbers when referring to the second antenna system 100b. When the reference numbers are used without the letters a or b, then it may refer to any of the first antenna system 100a or the second antenna system 100b or their components. Some of the details of the first antenna system 100a and the second antenna system 100b will now be described. However, all details that are described above with reference to FIG. 1 and an antenna system 100 in general also applies to the first antenna system 100a and the second antenna system 100b.

The first antenna system 100a comprises a first device 101a which is arranged to enable alignment of the first antenna 105a. A first mount 108a may be arranged between the first alignment means (not illustrated in FIG. 2) and the first antenna 105a. The first radio 110a is arranged to be connected to the first antenna 105a and the first device 101a. The first antenna system 100a comprises a first mounting structure 313a, e.g. a tower, a mast, a pole etc. The first antenna 105a is mounted to the first mounting structure 313a using any suitable mounting means, e.g. screws, welding, bolts and nuts etc. The first radio 110a may be mounted to the first mounting structure 313a, or it may be located at a distance from the first mounting structure 313a, but still being arranged to communicate with the first antenna 105a and the first device 101a. The first device 101a is arranged to automatically change the position of a first alignment means 109a.

Similarly, the second antenna system 100b comprises a second device 101b which is arranged to enable alignment of the second antenna 105b. A second mount 108b may be arranged between the second alignment means (not illustrated in FIG. 2) and the second antenna 105b. The second radio 110a is arranged to be connected to the second antenna 105b and the second device 101b. The second antenna system 100b comprises a second mounting structure 313b, e.g. a tower, a mast, a pole etc. The second antenna 105b is mounted to the second mounting structure 313b using any suitable mounting means, e.g. screws, welding, bolts and nuts etc. The second radio 110b may be mounted to the second mounting structure 313b, or it may be located at a distance from the second mounting structure 313b, but still being arranged to communicate with the second antenna 105b and the second device 101b. The second device 101b is arranged to automatically change the position of a second alignment means 109b.

FIG. 2 illustrates a communication channel 315 between the first antenna system 100a and the second antenna system 100b. The communication channel 315 may be a wired or wireless communication channel. The communication channel 315 may be used by the first antenna system 100a and the second antenna system 100b to communicate with each other, for example in the alignment process. For example, the first device 101a may communicate with the second device 101b via the communication channel 315.

When both sides of the link need to be aligned, two automated devices 101 coordinate the alignment through the communication channel 315. The communication can be over the radio link or there can be a separate communication channel, e.g. through the mobile network. The radio link may not be up and running until the antenna installation is complete. The communication channel 315 may be used for communication between the devices 101 even before the antenna installation is complete. By automating the alignment, no personnel needs to be in the mounting structure 313 at the time of alignment.

The first antenna 105a and the second antenna 105b may be of the same antenna type or they may be of different antenna types. Only one of the antenna systems 100 may comprise the device 101, or both antenna systems 100 may comprise the device 101. In other words, only one antenna 105 may be arranged to be automatically aligned by means of the device 101, and the other antenna 105 may be manually aligned, or both antennas 105 may be automatically aligned by means of the device 101. The antennas 105 may have the same or different size, they may be of the same or different brands etc.

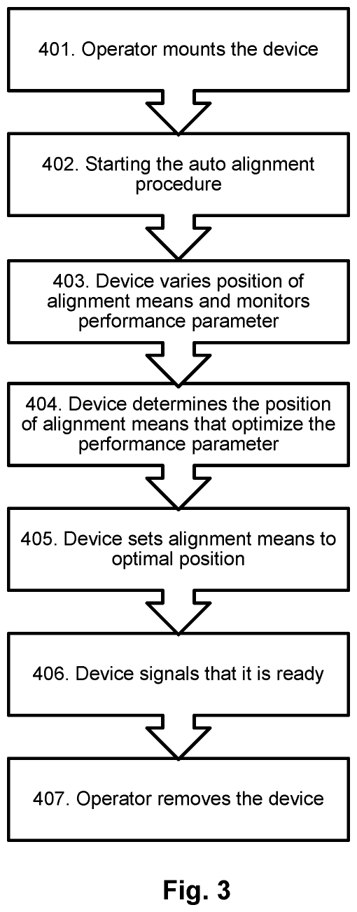

FIG. 3 is a flow chart illustrating an automated alignment procedure, i.e. automatic position change of the at least one alignment means 109 which leads to alignment of the antenna 105. The method comprises at least one of the following steps. The steps may be performed in any suitable order and not only in the order described below:

### Step 401

An operator, also referred to as an installer, a user etc., mounts the device 101 by connecting the manipulator 102 to the alignment means 109. The operator also connects the radio 110 to the device 101.

### Step 402

The alignment procedure is started. The alignment procedure may be started by the operator e.g. by pushing a start button on the device 101, by providing a start command via the user interface comprised in the device 101, via an application on a UE, e.g. a mobile phone, a tablet computer etc., connected to the device 101, a start command given through the radio 110 etc. Consequently, the device 101 obtains a trigger to start the alignment procedure and starts the alignment procedure. The alignment procedure may be automatically started when the device 101 detects that it has been connected to the alignment means 109.

### Step 403

The device 101 varies the position of the alignment means 109 and monitors at least one performance parameter received from the radio 110, i.e. it monitors at least one performance parameter while varying the position of the alignment means 109. The orientation may e.g. be swept from one end of the range to the other, while monitoring the performance parameter. The performance parameter may be for example RSL, signal quality, BLER etc.

### Step 404

The device 101 determines the position of alignment means 109 that optimizes the performance parameter. When the performance parameter is optimized, it fulfills a performance criterion. The performance criterion may be to maximize the RSL, signal quality, BLER etc. In other words, the device 101 determines the optimal position for the alignment means 109. The optimal position may be described as a position that leads to the performance parameter fulfilling a performance criterion.

### Step 405

The device 101 sets the alignment means 109 to the optimal position that was determined in step 404, i.e. the device 101 changes the position of the alignment means 109 to the optimal position. The alignment means 109 may be directly set to the optimal position in one single step, or the position change may be performed in multiple steps by gradually changing the position to arrive at the optimal position after a time period.

### Step 406

The device 101 provides an indication of that the position change is ready, e.g. it signals that it is ready.

The position change is determined to be ready when the optimal position change has been performed, and this is associated with the performance parameter fulfilling the performance criterion.

The indication may be provided for example through the user interface, e.g. via a lamp on the device 101, an audio signal from the device 101, a notification in an application in the UE connected to the device 101 or by any other means.

### Step 407

The operator removes the device 101 from the alignment means 109 and disconnects the device 101 from the radio 110 when the position change is finished.

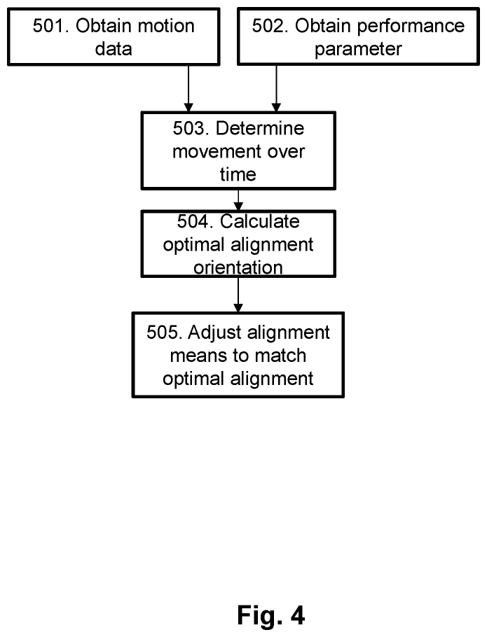

FIG. 4 is a flow chart illustrating an example of the method for aligning an antenna 105 when the mounting structure 313 is moving. The method comprises at least one of the following steps, which steps may be performed in any suitable order and not only in the order described below:

### Step 501

The device 101 may obtain motion data from a motion sensor. The motion sensor may be located at any suitable location, for example in the device 101, in the radio 110, in the antenna 105 etc. The device 101 may obtain the motion data from the motion sensor via a communication interface, and the communication interface may or may not be the same as the RSL interface. The motion data may be obtained during a time period, and the mounting structure 313 may move during the time period. The antenna 105 moves as a result of the movement of the mounting structure 313. Thus, the terms movement of the mounting structure 313 and movement of the antenna 105 may be used interchangeably herein.

The mounting structure 313 may be subject to external forces that may cause the mounting structure 313 to move. The movement of the mounting structure 313 may be for example to sway, i.e. the mounting structure 313 tilts backwards or forwards, causing the antenna 105 to tilt up or down with respect to the ground. The mounting structure 313 may twist left or right, causing the antenna 105 to rotate left or right. The movement may be thermal induced movement, it may be caused by wind, it may be caused by vibrations introduced by traffic in the surroundings of the antenna system 100 or it may have any other cause. The movement is unwanted and may cause for example misalignment of the antenna 105.

### Step 502

The device 101 obtains at least one performance parameter from the radio 110. The performance parameter may be for example RSL, signal quality, BLER etc. The at least one performance parameter may be obtained during a time period, and the mounting structure 313 may move during the time period.

Steps 501 and 502 may be performed in parallel, i.e. at the same time, or they may be performed after each other. Step 501 may be performed first and then step 502 may be performed, or step 502 may be performed first and then step 501 may be performed.

The motion data may be a performance parameter.

### Step 503

Based on the performance parameter, the device 101 determines movement of the antenna 105 over the time period. The movement of the antenna 105 may be determined based on both the performance parameter and the motion data.

When a motion sensor is not comprised in the antenna system 100 or when motion data is not obtainable, the performance parameter may be monitored over time, e.g. over a day in case of thermal bending or several seconds in case of wind sway and optimize the alignment to get the optimal performance parameter over time.

### Step 504

The device 101 calculates an optimal alignment of the antenna 105. The calculation is done based on the movement of the antenna 105 over the time period from step 503. The optimal alignment is associated with a position change of the alignment means 109 that leads to the optimal alignment. The optimal alignment is such that the performance parameter fulfills the performance criterion. The performance criterion may be predetermined, it may be determined by the operator and provided to the device 101 via the user interface etc.

### Step 505

The device 101 adjusts the alignment means 109 to match the optimal alignment that was determined in step 504. The alignment means 109 is adjusted by changing its position.

As mentioned above, the mounting structure 313 may be subject to movement, i.e. sway. The movement may cause misalignment of the antenna 105. The movement of the mounting structure 313 may have different reasons and thermal induced sway is one example. A challenge with thermal induced sway may be that the time of day during which the antenna alignment is done is important. Ideally, the antenna 105 is aligned at the center of the sway range, so there is enough margin to cope with sway in both directions. For example, when the mounting structure 313 sways from −0.2 to +0.8 deg over the course of the day, the best alignment position is 0.3 deg. For a human operator it is impossible to know the range and movement of the mounting structure 313 throughout the day.

The device 101 may be equipped with a motion sensor such as e.g. an Inertial Measurement Unit (IMU) that is arranged to record the motion of the antenna 105 over time. From this motion data and the performance parameter received from the radio 110, the device 101 may determine the center position of the sway and align the antenna 105 in the best orientation, i.e. the device 101 determines the position change of the alignment means 109 that corresponds to the best orientation.

This procedure is visualized in the flowchart in FIG. 4 which describes the alignment of antennas 105 when it is installed at non-optimal times. Non-optimal times may be for example during windy events. If the device 101 is kept on the antenna 105 for a longer time, for example during one or several days, it may obtain enough data to also compensate for thermal induced sway.

The radio 110 and/or the antenna 105 may have knowledge about the movement of its deployment, for example, it is equipped with a motion sensor, and it has recorded the movement over time. The device 101 may load the data from the node and uses it to align the antenna 105 in the best possible orientation. The term node may be used to refer to a unit that receives and transmits signal and may in this case comprise the radio 110 plus the antenna 105.

Alignment during wind-induced sway of the mounting structure 313 may be performed with a device 101 without IMU as follows. The device 101 may detect the maximum performance parameter value during a time-window that must be large enough to cover one entire sway cycle, i.e., on the order of a couple of seconds, and then update the antenna alignment step wise to maximize the maximum time-windowed performance parameter. Thus, the alignment procedure is slowed down somewhat as each antenna alignment modification must be followed by a complete time-window during which the antenna alignment completes at least one full sway cycle.

Alignment during thermal-induced sway of the mounting structure 313 may be performed with a device 101 without IMU as follows. The device 101 may detect the maximum performance parameter value during a time-window that must be large enough to cover one entire sway cycle, i.e., on the order of24 hours, and then update the antenna alignment step wise to maximize the maximum time-windowed performance parameter. Thus, the alignment procedure is slowed down significantly as each antenna alignment modification must be followed by a complete time-window during which the antenna alignment completes at least one full sway cycle.

Before any of the methods in FIG. 3 or FIG. 4 are performed, the operator may perform a rough manual alignment, i.e. a manual alignment is initially performed by the operator manually changing the position of the alignment means 109, for example by using a screwdriver or any other suitable manual tool. However, such manual alignment may be inaccurate and therefore automatic alignment done by the device 101 needs to be performed since it performs an alignment with higher accuracy compared to the manual alignment. The device 101 may be described as being arranged to do the final fine-tuned alignment, and this final fine-tuned alignment may be as exemplified in FIG. 3 and/or FIG. 4.

The device 101 may be removed after the alignment is finished, but it is also possible to leave the device 101 connected to the alignment means 109 even after the operator has left the site. This may be a way of enabling automatic realignment of the antenna 105 without the need for a site visit, or an easy upgrade to mitigate deployments that suffer from slow sway of the mounting structure 313, or to perform alignment during thermal-induced sway as described above.

The device 101 and the radio 110 may exchange information that the device 101 may use to determine the optimal alignment position, and one example of such information may be motion sensor data from a motion sensor comprised in the radio 110. The motion sensor data may be instantaneous data, historical data, data obtained during a time period, or a combination of these.

The device 101 may be equipped with one or more sensors that may be arranged to assist with the alignment. The device 101 may or may not comprise a motion sensor that may be arranged to determine the movement or tilt of the antenna 105. The antenna 105 may or may not comprise a motion sensor. The radio 110 may or may not comprise a motion sensor. The device 101 may comprise a spirit level, or electronically, an Inertial Measurement Unit (IMU), to align the polarization of the antenna 105 correctly.

As mentioned earlier, the device 101 may comprise a user interface. The user interface to operator may comprise one or more of the following:
An audio unit arranged to provide and obtain an audio signal,
A visual unit arranged to provide visual output, e.g. in the form of colored lights, text, images etc.
A wired or wireless connection between the device 101 and an external device such as the UE described earlier, that runs an application through which the operator may control the device 101.

The device 101 does not necessarily comprise a user interface. Instead, all control and communication of the device 101 may go through the radio 110 or the node. This may also allow the device 101 to be controlled through the network and allow for wider use of the device 101 than only alignment. For example, the alignment of an antenna 105 may be varied by a network controller while it is monitoring the interference on other links in the network, i.e. the whole network of radio links of the network operator. This may be useful in case an operator suspects that antenna type, e.g. ETSI Class 2 vs ETSI Class 3, to be a source of interference.

The device 101 may or may not comprise a processor. The processor may be arranged to take care of the alignment procedure. The algorithms for finding the best orientation of the antenna 105 may run on the processor of the node.

Advanced algorithms may also be used to determine the optimal position of the alignment means 109, for example a function, e.g. a Machine Learning (ML) algorithm, that learns how the position change of the alignment means 109 changes the alignment of the antenna 105 and can compensate for that. The device 101 may also rely on both motion sensor data and environmental parameters to determine the optimal alignment orientation. This is useful for mounting structures 313 that suffer from wind or thermal sway and when motion sensor data and weather data is available. The device 101 may obtain weather data from the UE of the operator, from a weather data storage memory, from a weather computer etc.

If a node is equipped with two radios 110, for example Cross Polarization Interference Canceller (XPIC), then the device 101 may support this by also optimizing the position of the alignment means 109 to minimize the cross-polarization interference between these two radios 110. The device 101 may then be arranged to connect to both radios 110 and obtain information of the XPIC about the Cross Polarization Interference (XPI) level. The device 101 may then also have a means of adjusting how the OrthoMode Transducer (OMT) is mounted on the antenna 105.

In case that antennas 105 on both sides of the link need to be aligned, e.g. the first antenna 105a and the second antenna 105b as exemplified in FIG. 2, the first device 101a may be arranged to communicate with another device, e.g. the second device 101b, that is used to align the second antenna 105b. This communication channel is illustrated with reference number 315 in FIG. 2 and may be through the mobile network, or through the link. The two devices 101, i.e. the first device 101a and the second device 101b, may be arranged to handle voice communication between the two ends of the link by, e.g., connecting to the operators' mobile phones, such that the personnel climbing the mounting structures 313 do not have to manipulate their phones.

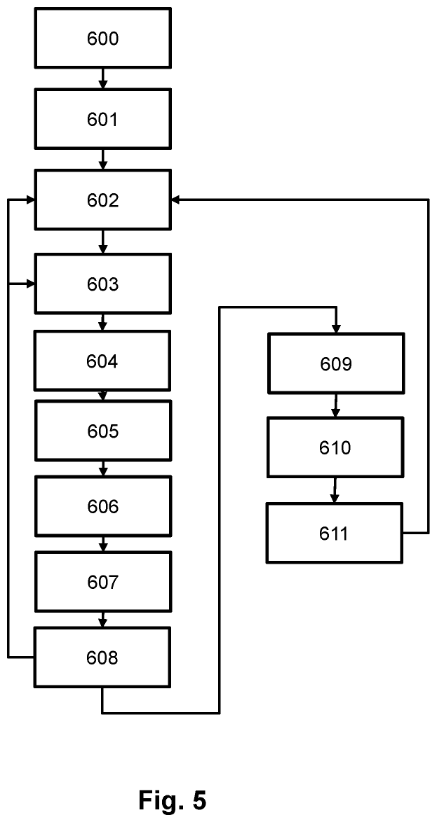

The method for changing position of at least one alignment means 109 to align an antenna 105 mounted to a mounting structure 313 will now be described with reference to the flowchart depicted in FIG. 5. An initial and manual alignment of the antenna 105 may have been performed by an operator before the device 101 is connected to the at least one alignment means 109, i.e. before step 600 is performed.

The method in FIG. 5 comprises at least one of the following steps. The steps may as well be carried out in another suitable order than described below:

### Step 600

This step corresponds to step 401 in FIG. 3. The device 101 connects to the at least one alignment means 109. The at least one alignment means 109 have been connected to the antenna 105 before connecting the device 101 to the at least one alignment means 109, but no position change with respect to alignment of the antenna 105 may have been done before connecting the device 101, or at least no fine tuning of the alignment of the antenna 105 may have been done before connecting the device. As mentioned earlier, there may be an antenna mount 108 between the at least one alignment means 109 and the antenna 105.

The device 101 may be connected to the at least one alignment means 109 by an operator, by a robotic connecting unit for example arranged on a drone or by any other means.

### Step 601

The device 101 may configure the radio 110 for the position change of the at least one alignment means 109. When the radio 110 is configured for the position change, it may enter a position change mode, e.g. alignment mode, where it is arranged to measure and report the at least one performance parameter.

When there are two radios 110, e.g. the first radio 110a and the second radio 110b, then both radios 110 may be configured for the position change by their respective devices 101a, 101b.

### Step 602

This step corresponds to step 403 in FIG. 3 and step 502 in FIG. 4. The device 101 obtains at least one performance parameter from the radio 110 associated with the antenna 105.

The device 101 may obtain the at least one performance parameter by sending a request for the at least one performance parameter to the radio 110 and receiving a response with the at least one performance parameter, the device 101 may obtain the at least one performance parameter at fixed time intervals from the radio 110, the device 101 may obtain the at least one performance parameter after each time a position change has been performed or the device 101 may obtain the at least one performance parameter at any other suitable time instance.

The radio 110 may be associated with the antenna 105 in that they are connected to each other, via a wired communication link, in that they are mounted to the same mounting structure 313 or they may be associated with each other in any other suitable way.

The at least one performance parameter may represent performance of the radio 110 during a time period.

The at least one performance parameter may be signal strength, RSL, Received Signal Strength Indicator (RSSI), Signal to Noise Ratio (SNR), Signal to Interference Ratio (SIR), Signal to Interference plus Noise Ratio (SINR), Bit Error Rate (BER), Block Error Rate (BLER), Mean Squared Error (MSE), throughput, etc.

Step 602 may be iterated until the performance parameter which is associated with the position change has fulfilled a performance criterion. Thus, the at least one performance parameter may be obtained again after step 608 has been performed, i.e. after the position has been changed. The performance parameter may then be compared with the performance criterion to determine whether or not it has been fulfilled. The performance criterion may be associated with optimal antenna alignment.

The device 101 may obtain and monitor the at least one performance parameter during the position change, e.g. each time a position change in step 608 has been performed.

### Step 603

This step corresponds to step 501 in FIG. 4. The device 101 may obtain motion data associated with movement of the antenna 105. The motion data may be associated with misalignment of the antenna 105.

The motion data may represent movement of the antenna 105 during a time period. The movement may be due to sway in the mounting structure 313 caused by for example wind, heavy-duty vehicles driving nearby the mounting structure 313 etc.

The motion data may be obtained from a motion sensor.

Step 603 may be iterated until the performance parameter associated with the position change in step 608 has fulfilled a performance criterion. Thus, the motion data may be obtained again after step 608 has been performed, i.e. after the position has been changed. The motion data may then be compared with the performance criterion to determine whether or not it is fulfilled. The performance criterion may be predetermined.

The device 101 may obtain and monitor the motion data before, during and/or after the position change, e.g. each time a position change in step 608 has been performed.

### Step 604

This step corresponds to step 404 in FIG. 3 and step 504 in FIG. 4. The device 101 determines a position change of the at least one alignment means 109 based on the at least one performance parameter, and thereby align the antenna 105. The position change of the at least one alignment means 109 may be any suitable position change, for example a number of turns that the at least one alignment means 109 should be twisted, it may be a sideways position change of the at least one alignment means 109. The position change of the at least one alignment means 109 may be dependent on the design of the at least one alignment means 109. For example, if the at least one alignment means 109 is a screw, then the position change may be a number of turns that it should be twisted. The device 105 may be arranged to measure and control the position change so that a predetermined position can be achieved and repeated.

The position change of the at least one alignment means 109 may be determined further based on the motion data from step 603.

The antenna 105 should be aligned in order to achieve optimal performance. Since the alignment of the antenna 105 is a result of the position change of the at least one alignment means 109, the position change is associated with optimal performance. The position change may be referred to as an optimal position change. The optimal performance is represented by a performance criterion. When the performance has reached the performance criterion, then the performance may be considered to be an optimal performance. For example, the position change may be such that a maximum received power for the antenna 105 is achieved.

The position change may be represented by a number of turns that the alignment means 109 should be twisted, a number of mm that the alignment means 109 should be moved in lateral or longitudinal direction etc. As a consequence of the position change of the at least one alignment means, the orientation of the antenna 105 is consequently changed, and the orientation change of the antenna 105 is related to a rotational movement. Thus, the antenna is rotated, and thereby aligned.

### Step 605

The device 101 may be a first device 101a and the antenna 105 may be a first antenna 105a. The first device 101a may communicate with a second device 101b associated with a second antenna 105b. The first device 101a may communicate with the second device 101b by providing information indicating how to synchronize the alignment of the two antennas 105a, 105b, such that they do not interfere with each other. The first device 101a may communicate with the second device 101b to make sure that only one antenna 105 at the time is fine-tuning its alignment.

Another example of the communication between two devices 101a, 101b may be in case of cross polarization interference minimization. It may be that the optimal rotation of the first antenna 105a is outside its range of rotation. Then, communication may take place to start rotating the other antenna 105b. Note that this may only happen if the initial manual polarization alignment is too far off, i.e. that the initial manual polarization alignment has exceeded a threshold.

### Step 606

The device 101 may determine or identify a sway scenario based on:
the least one performance parameter, or
the motion data, or
both the at least one performance parameter and the motion data.

The sway may be associated with misalignment of the antenna 105. The sway scenario may be one of several possible sway scenarios. The sway scenario describes sway or movement of the mounting structure 313. Below are some examples of sway scenarios:
i) No mounting structure 313 is swaying.
ii) At least one mounting structure 313 is swaying, but the sway, represented by motion data, is below or at an acceptance threshold.
iii) Only the first mounting structure 313a is swaying.
iv) Only the second mounting structure 313b is swaying.
v) Both the first mounting structure 313a and the mounting structure 313b are swaying.
   It may be necessary to determine or identify the sway scenario in order to perform the appropriate alignment procedure, which is determined in step 607.

### Step 607

The device 101 may determine an alignment procedure to be performed according to the sway scenario. The alignment procedure comprises to change the position of the at least one alignment means 109, i.e. to perform step 608. The alignment procedure may describe how to change the position of the at least one alignment means 109. The alignment procedure may be any suitable alignment procedure mentioned herein, for example with or without a motion sensor, taking sway into consideration or not, wind sway or thermal sway, single sided alignment or both sides to be aligned etc.

### Step 608

This step corresponds to step 405 in FIG. 3 and step 505 in FIG. 4. The device 101 performs the position change of the at least one alignment means 109 as determined earlier, and thereby aligns the antenna 105.

The device 101 may perform the position change by for example the actuator changing the position of the at least one alignment means 109.

It may be only necessary to perform one position change in order for the at least one performance parameter to fulfill the performance criterion, or it may be necessary to perform multiple position changes in order for the at least one performance parameter to fulfill the performance criterion. The position change may be stopped when the optimal performance has been reached, i.e. when the at least one performance parameter fulfills the performance criterion. The at least one performance parameter may be compared with the performance criterion in order to determine whether or not it has been fulfilled.

The device 101 may be arranged to be disconnected from the at least one alignment means 109 after the position has been changed to the determined position. The device 101 may be arranged to be disconnected from the at least one alignment means 109 when the at least one performance parameter has fulfilled the performance criterion. The device 101 may be arranged to continue being connected to the at least one alignment means 109 after the position has been changed to the determined position for an additional position change of the at least one alignment means 109.

This decision may be based on at least one performance parameter obtained after the position change has been performed, and a comparison with the at least one performance parameter and the performance criterion. When a result of the comparison indicates that the performance criterion has been fulfilled, possibly with some tolerance, then it may be an indication of that the position change is completed and it may be determined to disconnect the device 101 from the at least one alignment means 109. When the result of the comparison indicates that the at least one performance parameter has fulfilled the performance criterion possibly with some tolerance, it may be determined, e.g. predetermined, to keep the device 101 connected to the at least one alignment means 109.

Cross-polarization interference between at least two radios 110 should be minimized. It may be sufficient to rotate only one antenna 105a/OMT to minimize cross-polarization interference, but it may be that the optimal rotation is outside the range of rotation of that antenna 105a/OMT, then communication may take place to start rotating the other antenna 105b/OMT.

The position change of the at least one alignment means 109 may be associated with minimization of cross-polarization interference between at least two radios 110 when they both are connected to the antenna 105, i.e. connected to the same antenna 105 and the same mounting structure 313. Minimization of cross-polarization interference may comprise that the cross-polarization interference is below an interference threshold.

When the device 101 is a first device 101a and the antenna 105 is a first antenna 105a, then the first antenna 105a and the second antenna 105b may be aligned with respect to each other.

The first antenna 105a and the second antenna 105b may be aligned with respect to each other by:
performing a position change of at least one first alignment means 109a connected to the first antenna 105a while the position of at least one second alignment means 109 connected the second antenna 105b is not changed; and
performing a position change of the at least one second alignment means 109b connected to the second antenna 105b while the position of the at least one first alignment means 109a connected first antenna 105a is not changed.

The first antenna 105a and the second antenna 105b may be aligned with respect to each other in a sequential way. The first antenna 105a is aligned while the second antenna 105b is not moved, then the second antenna 105b is aligned while the first antenna 105a is not moved, then the first antenna 105a is again aligned etc. until the at least one performance parameter has fulfilled the performance criterion.

The position change of the at least one first alignment means 109a and the at least one second alignment means 109b may be performed until the at least one performance parameter for each of the first antenna 105a and the second antenna 105b has fulfilled the performance criterion.

As mentioned above, the at least one performance parameter may be continuously monitored during the position change. For example, in case of multiple position changes, i.e. multiple antenna alignments, the at least one performance parameter may be obtained before and after each position change and compared to the performance criterion to determine if it is fulfilled or not. If it is not fulfilled, then it may be an indication of that further position changes may need to be performed.

### Step 609

This step corresponds to step 406 in FIG. 3. The device 101 may provide a confirmation of the changed position after it has been completed.

### Step 610

After the position change of the alignment means 109 has been completed, i.e. when the performance criterion is fulfilled, the antenna 105 may be fastened in the current position. As mentioned earlier, there may be separate fastening means arranged to hold the antenna 105 in place, i.e. to fix the antenna 105 in the current position, i.e. the position which currently fulfills the performance criterion. The separate fastening means may be fastened, e.g. tightened, manually or automatically by using the device 101.

The device 101 may determine that the antenna 105 has been fastened to the mounting structure 313 in its current position when the position change of the at least one alignment means 109 has been completed.

Note that the fastening of the antenna 105 to the mounting structure, e.g. by means of a fastening means, is performed after the alignment of the antenna 105 has been completed. Thus, the alignment of the antenna 105 and the fastening are separate procedures.

The device 101 may determine that the antenna 105 has been fastened to the mounting structure 313 in its current position by receiving user input via the user interface, by the fastening means providing fastening completed information to the device 101 or by any other suitable means.

Step 610 may comprise to provide instructions to an operator to manually fasten the antenna 105, or to trigger a fastening procedure to be performed by the device 101.

### Step 611

The device 101 may obtain the at least one performance parameter after the fastening in step 610 has been completed.

The fastening of the antenna 105 that was performed in step 610 may lead to misalignment of the antenna 105. To detect this misalignment, the at least one performance parameter may be obtained after the fastening has been performed and then compared with the performance criterion. If the performance criterion is not fulfilled anymore, the fastening may have caused a misalignment. To compensate for this misalignment, an additional position change of the at least one alignment means 109 may be performed and repeated until the performance criterion is fulfilled again. Before the additional position change of the at least one alignment means 109 is performed, the fastening means may need to be loosened, and then the device 101 goes back to performing step 602.

The device 101 may perform one or more additional position changes of the at least one alignment means 109 when the at least one performance parameter that was obtained in step 611 does not fulfill the performance criterion after the fastening has been completed. The additional position change may be performed until the performance criterion is fulfilled, and consequently the at least one performance parameter may be obtained after each additional position change has been performed and compared with the performance criterion.

The device 101 may be arranged to only manipulate the at least one alignment means 109, while the operator manually manipulates the fastening means. The device may check the at least one performance parameter before and after the fastening and it may indicate if the fastening has deteriorated the alignment of the antenna 105 or not. The device 101 may learn the impact of the fastening and compensate for the misalignment before asking the operator to perform fastening. This may be used in future fastening procedures.

The at least one performance parameter may be compared with the performance criterion before and after the position change of the at least one alignment means 109. In addition, the at least one performance parameter may be compared with the performance criterion before and after the fastening of the antenna 105 to the mounting structure 313.

When the at least one performance parameter obtained after the fastening does not fulfill the performance criterion, the device 101 may determine to unfasten the antenna 105 from the mounting structure 313. The device 101 may send instructions to the operator to manually unfasten the antenna 105 or it may trigger an unfastening procedure to be performed by the device 101.

This may be summarized as follows: (i) iterative alignment by maximizing the performance parameter, and then (ii) fastening of the antenna 105 while monitoring that the performance of the antenna 105 is not degraded by the fastening procedure. With the monitoring of the performance of the antenna 105 during the fastening procedure and the iteration of the alignment, a possible performance degradation during the fastening may be identified and compensated for during a repeated alignment procedure.

As mentioned earlier, the device 101 is arranged to perform the alignment fine-tuning but fastening of the antenna 105 to the mounting structure 313 may be done manually. However, there may be a risk that the manual fastening impacts the alignment. In such cases, it may be necessary to unfasten the antenna 105 from the mounting structure 313 and perform at least one additional alignment procedure. This may be summarized as follows:
obtaining the at least one performance parameter after the position change of the at least one alignment means has been completed,
instructing the operator to fasten the antenna 105 manually,
obtaining the at least one performance parameter after the manual fastening has been completed,
comparing the at least one performance parameter obtained before and after the manual fastening,
instructing the operator to undo the fastening if the at least one parameter value was degraded by the fastening,

The operator may provide information to the device 101 once the fastening and/or unfastening has been completed. The above may be the iterated until there is no degradation of the performance parameter(s) by the fastening.

Optionally, if the fastening degrades the performance of the antenna 105, i.e. the at least one performance parameter does not fulfill the performance criterion after the fastening has been completed, the device 101 may try to compensate for the impact of manual fastening beforehand, i.e. the learning procedure, for example by using motion data. This completes the description of FIG. 5.

The device 101 for changing position of at least one alignment means 109 to align an antenna 105 mounted to a mounting structure 313. The device 101 is arranged to perform the method described herein, e.g. as illustrated in one or more of FIGS. 3-5.

A computer program product comprising program code for performing, when executed by a processing circuitry, the method described herein, e.g. as illustrated in one or more of FIGS. 3-5.

A non-transitory computer-readable storage medium comprising instructions, which when executed by a processing circuitry, cause the processing circuitry to perform the method described herein, e.g. as illustrated in one or more of FIGS. 3-5.

As mentioned earlier, the device 101 may comprise a processor. The method for changing position of the at least one alignment means 109 may be implemented through one or more processors, such as the processor in the device 101, together with computer program code for performing the functions described herein. The processor may be for example a Digital Signal Processor (DSP), Application Specific Integrated Circuit (ASIC) processor, Field-programmable gate array (FPGA) processor or microprocessor. The program code mentioned above may also be provided as a computer program product, for instance in the form of a data carrier carrying computer program code for performing the present disclosure herein when being loaded into the device 101. One such carrier may be in the form of a CD ROM disc. It is however feasible with other data carriers such as a memory stick. The computer program code can be provided as pure program code on a server and downloaded to the device 101.

As also mentioned earlier, the device 101 may comprises a memory. The memory may comprise one or more memory units. The memory is arranged to be used to store obtained information, store data, configurations, performance parameter, performance criterion, position change information, motion data, and applications etc. to perform the methods herein when being executed in the device 101.

Summarized, the device 101 is placed on the alignment means 109 of the antenna 105. The alignment means 109 is manipulated using actuators and the device 101 uses performance parameters from the radio 110 to tune the alignment of the antenna 105 to achieve optimal alignment.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The steps of the methods may be performed in another order than the order in which they appear herein.

1. A method performed by a device for changing position of at least one alignment means to align a radio communication antenna mounted to a mounting structure, the method comprises:
connecting the device to the at least one alignment means;
obtaining at least one performance parameter from a radio communication device associated with the radio communication antenna;
determining a position change of the at least one alignment means based on the at least one performance parameter; and
performing the position change of the at least one alignment means and thereby aligning the radio communication antenna.

2. The method of claim 1, wherein the at least one performance parameter represents performance of the radio communication device during a time period.

3. The method of claim 1, wherein
the method further comprises obtaining motion data associated with movement of the radio communication antenna; and wherein the position change of the at least one alignment means is determined further based on the motion data.

4. The method of claim 3, wherein
the motion data represents movement of the radio communication antenna during a time period.

5. The method of claim 1, wherein
the device is arranged to be disconnected from the at least one alignment means after the position has been changed to the determined position; or
the device is arranged to continue being connected to the at least one alignment means after the position has been changed to the determined position for an additional position change of the at least one alignment means.

6. The method of claim 1, wherein
the position change of the at least one alignment means is associated with minimization of cross-polarization interference between at least two radio communication devices when they both are connected to the radio communication antenna.

7. The method of claim 1, wherein
the device is a first device,
the radio communication antenna is a first radio communication antenna,
the method further comprises communicating with a second device associated with a second radio communication antenna, and
the first radio communication antenna and the second radio communication antenna are aligned with respect to each other.

8. The method of claim 7, wherein
the first radio communication antenna and the second radio communication antenna are aligned with respect to each other by:
performing a position change of at least one first alignment means connected to the first radio communication antenna while the position of at least one second alignment means connected the second radio communication antenna is not changed; and
performing a position change of the at least one second alignment means connected to the second radio communication antenna while the position of the at least one first alignment means connected first radio communication antenna is not changed, and
the position change of the at least one first alignment means and the at least one second alignment means is performed until the at least one performance parameter for each of the first radio communication antenna and the second radio communication antenna fulfills a performance criterion.

9. The method of claim 3, wherein
the method further comprises:
determining a sway scenario based on one or both of the least one performance parameter and the motion data; and
determining an alignment procedure to be performed according to the sway scenario, wherein the alignment procedure comprises to change the position of the at least one alignment means.

10. The method of claim 1, wherein an initial and manual alignment of the radio communication antenna has been performed by an operator before the device is connected to the at least one alignment means.

11. The method of claim 1, wherein
the method further comprises configuring the radio communication device for the position change of the at least one alignment means.

12. The method of claim 1, wherein
the method further comprises providing a confirmation of the changed position after it has been completed.

13. The method of claim 1, wherein
the obtaining at least one performance parameter and the determining the position change of the at least one alignment means and the performing the position change of the at least one alignment means are iterated until the at least one performance parameter has fulfilled a performance criterion.

14. The method of claim 1, wherein
the method further comprises:
determining that the radio communication antenna has been fastened to the mounting structure in its current position when the position change of the at least one alignment means has been completed;
obtaining the at least one performance parameter after the fastening has been completed;
determining to unfasten the radio communication antenna from the mounting structure when the at least one performance parameter does not fulfill the performance criterion after the fastening has been completed; and
performing additional position change of the at least one alignment means when the radio communication antenna has been unfastened, wherein the additional position change is performed until the performance criterion is fulfilled.

15. A device, the device comprising:
processing circuitry, wherein the device is operable to perform the method of claim 1.

16. A computer program product comprising a non-transitory computer readable medium storing program code for performing, when executed by a processing circuitry, the method of claim 1.

17. (canceled)
